(19) United States
(12) Patent Application Publication
(10) Pub. No.: US 2026/0073725 A1
(43) Pub. Date: Mar. 12, 2026

(54) APPARATUS FOR IDENTIFYING ENTRY FIELDS IN ELECTRONIC DOCUMENTS BASED ON ARTIFICIAL INTELLIGENCE AND METHOD FOR IDENTIFYING ENTRY FIELDS IN ELECTRONIC DOCUMENTS USING SAME

(71) Applicant: FORCS CO., LTD., Seoul (KR)

(72) Inventors: Mi Kyung PARK, Seoul (KR); Chan hwi CHOI, Seoul (KR); Hyun Young CHOI, Seoul (KR)

(21) Appl. No.: 19/389,009

(22) Filed: Nov. 13, 2025

Related U.S. Application Data
(63) Continuation of application No. PCT/KR2024/007154, filed on May 27, 2024.

(30) Foreign Application Priority Data
Jul. 13, 2023 (KR) 10-2023-0091003

(51) Int. Cl. G06V 30/412; G06F 40/186; G06V 30/416

(52) U.S. Cl. CPC G06V 30/412; G06F 40/186; G06V 30/416

(57) ABSTRACT

An apparatus for identifying entry fields in electronic documents based on artificial intelligence and a method for identifying entry fields in electronic documents using the same are provided. The apparatus for identifying entry fields in electronic documents based on artificial intelligence includes an input unit that acquires an original electronic document in which entry field information including type information and position information is not identified, a feature extraction unit that extracts feature information for deriving the entry field information from the original electronic document in consideration of the data type of the original electronic document, and a field classification unit that identifies the entry field information from the feature information.

### BACKGROUND OF THE INVENTION

The present disclosure relates to an apparatus for identifying entry fields in electronic documents based on artificial intelligence (AI) and a method for identifying entry fields in electronic documents using the same. For example, the present disclosure relates to a document layout analysis (DLA) technique for deriving entry field information from an original electronic document in which entry field information is not identified by using an AI model.

In general, preparation of an electronic document is performed by the user reviewing the content of the electronic document in a format to be written, and directly determining and filling the entry fields (input boxes) required for preparation of the document.

However, in order to utilize such an electronic document as a format in an electronic signature or electronic contract system, an electronic document template is required. The electronic document template is a fillable format-type electronic document in which information on the positions, sizes, and types of entry fields to be filled in the electronic document are recorded and identified.

Accordingly, there is a need to develop a technology for determining the positions, sizes, and types of entry fields by extracting characteristic information according to the type of the electronic document from the original electronic document in which the positions, sizes, and types of entry fields are not identified.

The technology underlying the present disclosure is disclosed in Korean Registered Patent Publication No. 10-1357710.

An objective to be achieved by the present disclosure is to provide an apparatus for identifying entry fields in electronic documents based on AI and a method for identifying entry fields in electronic documents using the same, in which characteristic information is extracted from an original electronic document in which the information about the position, size, and type of entry fields has not been identified, according to the type of the electronic document, so as to determine the position, size, and type of the entry fields.

However, the technical objectives to be achieved by the exemplary embodiments of the present disclosure are not limited to those described above, and other technical objectives may also exist.

### SUMMARY OF THE INVENTION

As a technical means for achieving the above objectives, a first aspect of the present disclosure provides an apparatus for identifying entry fields in electronic documents based on AI, the apparatus can include: at least one processor and at least one memory for storing a computer code, wherein the computer code, when executed by the at least one processor, is configured, with the at least one processor, to cause the apparatus to: acquire an original electronic document in which entry field information including type information and position information of the entry fields is not identified; extract feature information for deriving the entry field information from the original electronic document in consideration of the type of the original electronic document; and identify the entry field information from the feature information.

According to an exemplary embodiment of the present disclosure, the computer program code is further configured to generate an electronic document template in which the entry fields are identified by combining the original electronic document and the entry field information, but is not limited thereto.

According to an exemplary embodiment of the present disclosure, the computer program code is further configured to output an interface for receiving user input corresponding to the entry field information using the electronic document template, but is not limited thereto.

According to an exemplary embodiment of the present disclosure, the type can include image data, and the computer program code is further configured to extract, as the feature information, probability information associated with the type information corresponding to each pixel included in the image data by inputting the probability information into a pre-trained deep learning model, but is not limited thereto.

According to an exemplary embodiment of the present disclosure, the probability information can include a plurality of probability values corresponding to each of probabilities that each pixel corresponds to text, a blank, and a preset entry field type, but is not limited thereto.

According to an exemplary embodiment of the present disclosure, the original electronic document can include structured data having a plurality of cells, and the computer program code is further configured to extract format information and content information of each of the plurality of cells as the feature information, but is not limited thereto.

According to an exemplary embodiment of the present disclosure, the original electronic document can include a plurality of analysis sections, and the computer program code is further configured to extract the plurality of analysis sections constituting the document data through layout analysis of the original electronic document, and can extract format information and content information of each of the plurality of analysis sections as the feature information, but is not limited thereto.

According to an exemplary embodiment of the present disclosure, the computer program code is further configured to identify the type information based on the probability information, and can recognize position information and size information of the corresponding entry field based on a pixel having the largest probability value, but is not limited thereto.

According to an exemplary embodiment of the present disclosure, the computer program code is further configured to input the feature information into a pre-built AI model to derive whether each of the plurality of cells corresponds to an entry field and probabilities associated with the type information, and can recognize the type information and position information of each of the plurality of cells based on the derived probabilities, but is not limited thereto.

According to an exemplary embodiment of the present disclosure, the computer program code is further configured to utilize the feature information as input of an ensemble model to derive probabilities regarding whether each of the plurality of analysis sections corresponds to an entry field, and can determine the position information such that no interference exists between one or more of the plurality of analysis sections identified as corresponding to entry fields and the remainder of the plurality of analysis sections identified as not corresponding to entry fields, but is not limited thereto.

Additionally, a second aspect of the present disclosure provides a computer-implemented method for identifying entry fields in an electronic document based on AI, the method can include: acquiring an original electronic document in which entry field information including type information and position information of the entry fields is not identified; extracting feature information for deriving the entry field information from the original electronic document in consideration of the type of the original electronic document; and identifying the entry field information from the feature information.

According to an exemplary embodiment of the present disclosure, the method can further include generating an electronic document template in which the entry fields are identified by combining the original electronic document and the entry field information, but is not limited thereto.

According to an exemplary embodiment of the present disclosure, the method can further include outputting an interface for receiving user input corresponding to the entry field information using the electronic document template, but is not limited thereto.

According to an exemplary embodiment of the present disclosure, the original electronic document can include image data, and the extracting of the feature information can include extracting, as the feature information, probability information associated with the type information corresponding to each pixel included in the image data by inputting the probability information into a pre-trained deep learning model, but is not limited thereto.

According to an exemplary embodiment of the present disclosure, the probability information can include a plurality of probability values corresponding to probabilities that each pixel corresponds to text, a blank, and each preset entry field type, but is not limited thereto.

According to an exemplary embodiment of the present disclosure, the original electronic document can include structured data having a plurality of cells, and the extracting of the feature information can include extracting format information and content information of each of the plurality of cells as the feature information, but is not limited thereto.

According to an exemplary embodiment of the present disclosure, the original electronic document can include a plurality of analysis sections, and the extracting of the feature information can include extracting a plurality of analysis sections constituting the original electronic document through layout analysis of the original electronic document, and extracting format information and content information of each of the plurality of analysis sections as the feature information, but is not limited thereto.

According to an exemplary embodiment of the present disclosure, the identifying can include identifying the type information based on the probability information, and recognizing position information and size information of the corresponding entry field based on a pixel having the largest probability value, but is not limited thereto.

According to an exemplary embodiment of the present disclosure, the identifying of the entry field information can include inputting the feature information into a pre-built AI model to derive whether each of the plurality of cells corresponds to an entry field and probabilities associated with the type information, and recognizing the type information and position information of each of the plurality of cells based on the derived probabilities, but is not limited thereto.

According to an exemplary embodiment of the present disclosure, the identifying of the entry field information can include utilizing the feature information as input to an ensemble model to derive probabilities regarding whether each of the plurality of analysis sections corresponds to an entry field, and determining the position information so that interference does not occur between one or more of the plurality of the analysis sections identified as corresponding to entry fields and the remainder of the plurality of the analysis sections identified as not corresponding to entry fields, but is not limited thereto.

The above-described means for solving the aspect are merely illustrative and should not be construed as intending to limit the present disclosure. In addition to the above-described exemplary embodiments, additional embodiments can be provided in the drawings and the detailed description of the present disclosure.

According to the above-described means for solving the aspect of the present disclosure, an apparatus for identifying entry fields in electronic documents and a method for identifying entry fields in electronic documents using the same is provided, in which entry field information is identified by extracting characteristic information according to the type of the original electronic document from the original electronic document in which entry field information including type information and position information is not identified, thereby generating an electronic document template in which the entry fields are identified.

According to the above-described means for solving the aspect of the present disclosure, an electronic document template that a user fills in can be provided by automatically analyzing, using an AI model, entry fields to be filled by the user in the electronic document, from original electronic documents that can have various formats such as PDF files, image files, and Office files.

According to the above-described means for solving the aspect of the present disclosure, the positions, sizes, and types of entry fields can be determined by extracting characteristic information according to the type of file from an ordinary electronic document in which information on the positions, sizes, and types of input fields is not included.

However, the effects obtainable from the present disclosure are not limited to the above-described effects, and other effects can exist.

### BRIEF DESCRIPTION OF THE DRAWINGS

FIG. 1 is a schematic configuration diagram of a system for identifying entry fields in electronic documents according to an exemplary embodiment of the present disclosure.

FIG. 2 is a schematic configuration diagram of an apparatus for identifying entry fields in electronic documents according to an exemplary embodiment of the present disclosure.

FIG. 3 is a conceptual diagram schematically illustrating an operation process of the apparatus for identifying entry fields in electronic documents according to an exemplary embodiment of the present disclosure.

FIG. 4 is a diagram illustrating generation of an electronic document template from an original electronic document by the apparatus for identifying entry fields in electronic documents according to an exemplary embodiment of the present disclosure.

FIG. 5 is a flowchart illustrating a method for identifying entry fields in electronic documents according to an exemplary embodiment of the present disclosure.

### DETAILED DESCRIPTION OF THE INVENTION

Hereinafter, exemplary embodiments of the present disclosure will be described in detail with reference to the accompanying drawings so that those skilled in the art to which the present disclosure pertains may easily carry out the present disclosure. However, the present disclosure may be embodied in various different forms, and is not limited to the exemplary embodiments described herein. In the drawings, in order to clearly describe the present disclosure, parts not related to the description are omitted, and throughout the disclosure, similar reference numerals are given to similar parts.

Throughout the present disclosure, when a part is referred to as being “connected” to another part, it is intended to include not only a case where it is “directly connected” but also a case where it is “electrically connected” or “indirectly connected” with another element interposed therebetween.

Throughout the present disclosure, when a member is referred to as being “on,” “above,” “upper,” “under,” “below,” or “lower” another member, it is intended to include not only a case where one member is in contact with another member, but also a case where another member is present between the two members.

Throughout the present disclosure, when a part is referred to as “including” a component, it means that the part may further include other components, rather than excluding other components unless otherwise specifically described.

Hereinafter, an apparatus for identifying entry fields in electronic documents based on AI and a method for identifying entry fields in electronic documents using the same according to the present disclosure will be specifically described with reference to implementation embodiments and exemplary embodiments and the drawings. However, the present disclosure is not limited to such implementation embodiments, exemplary embodiments, and the drawings.

As a technical means for achieving the above objectives, a first aspect of the present disclosure provides an apparatus 100 for identifying entry fields in electronic documents based on AI, the apparatus 100 can include: an input unit 110 that acquires an original electronic document 1 in which entry field information including type information and position information of the entry fields is not identified; a feature extraction unit 120 that extracts feature information for deriving the entry field information from the original electronic document 1 in consideration of the type of the original electronic document 1; and a field classification unit 130 that identifies the entry field information from the feature information.

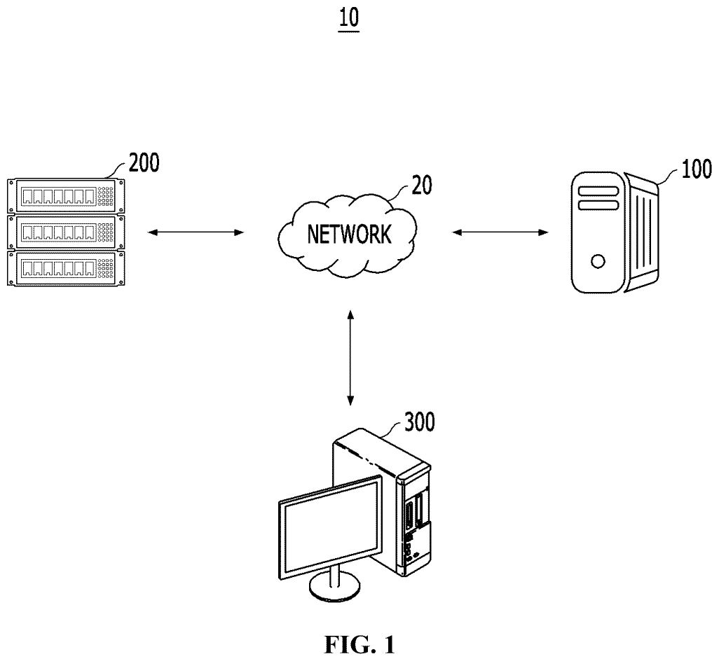

FIG. 1 is a schematic configuration diagram of a system 10 for identifying entry fields in electronic documents according to an exemplary embodiment of the present disclosure.

Referring to FIG. 1, the system 10 for identifying entry fields in electronic documents according to an exemplary embodiment of the present disclosure can include the apparatus 100 for identifying entry fields in electronic documents according to an exemplary embodiment of the present disclosure, a database 200, and a user terminal 300.

The apparatus 100 for identifying entry fields in electronic documents, the database 200, and the user terminal 300 can communicate with each other via a network 20. The network 20 refers to a connection structure in which information can be exchanged between respective nodes such as terminals and servers, and examples of such a network 20 include a 3rd generation partnership project (3GPP) network, an long term evolution (LTE) network, a 5G network, a world interoperability for microwave access (WIMAX) network, the Internet, a local area network (LAN), a wireless local area network (WLAN), a wide area network (WAN), a personal area network (PAN), a Wi-Fi network, a Bluetooth network, a satellite broadcasting network, an analog broadcasting network, and a digital multimedia broadcasting (DMB) network, but are not limited thereto.

In the description of the exemplary embodiments of the present disclosure, the database 200 can be a server or device for storing the original electronic document 1, an electronic document template 2 in which entry field information is combined, and the like. In this regard, the apparatus 100 for identifying entry fields in electronic documents disclosed in the present disclosure can acquire the original electronic document 1 from the database 200, identify entry field information from the acquired original electronic document 1 to generate the electronic document template 2 in which the entry field information is identified, and store the generated electronic document template 2 in the database 200, but are not limited thereto.

The user terminal 300 can be implemented by, for example, any type of wireless communication device such as a smartphone, smart pad, tablet PC, personal communication system (PCS), global system for mobile communication (GSM), personal digital cellular (PDC), personal handyphone system (PHS), personal digital assistant (PDA), international mobile telecommunication (IMT)-2000, code division multiple access (CDMA)-2000, W-code division multiple access (W-CDMA), and a wireless broadband Internet (Wibro) terminal.

In particular, the user terminal 300 can include various audio devices and driving devices utilizing various newly emerging communication technologies such as smart speakers, smart cars, smart appliances, wearable devices, and augmented reality devices (VR/MR).

The user terminal 300 can be understood as various devices equipped with a display screen capable of displaying information on the electronic document template 2 in which entry fields are identified, and when the user terminal 300 is not equipped with a display screen, it can include an additional terminal having a display capable of displaying information on the electronic document template 2 in which entry fields are identified.

Meanwhile, the user terminal 300 can include an application unit (not illustrated) configured to transmit a user input received from a user to the apparatus 100 for identifying entry fields in electronic documents or to receive a processing result for the user input in association with the apparatus 100 for identifying entry fields in electronic documents.

According to an exemplary embodiment of the present disclosure, the application unit can include a virtual AI assistant application. Examples of the virtual AI assistant application can include virtual AI assistant services such as Siri, Google Assistant, Alexa, Cortana, Bixby, Nugu, and Clova, but are not limited thereto.

According to another exemplary embodiment of the present disclosure, the application unit can include a messenger application. Examples of the messenger application can include messenger services such as KakaoTalk, MyPeople, LINE, TikTok, BuddyBuddy, SayClub, MSN Messenger, Yahoo Messenger, NateOn, Daum WizGenie, DaumMessenger, KTiman Messenger, Facebook, Telegram, and WhatsApp, but are not limited thereto.

Also, referring to FIG. 1, as described in detail below, the apparatus 100 for identifying entry fields in electronic documents disclosed in the present disclosure can be equipped with an AI model for recognizing entry field information including position, size, and type of the entry field from the original electronic document 1 acquired from the database 200 by extracting characteristic information from the original electronic document 1, and generating the electronic document template 2 in which entry fields are identified by combining the entry field information with the original electronic document 1.

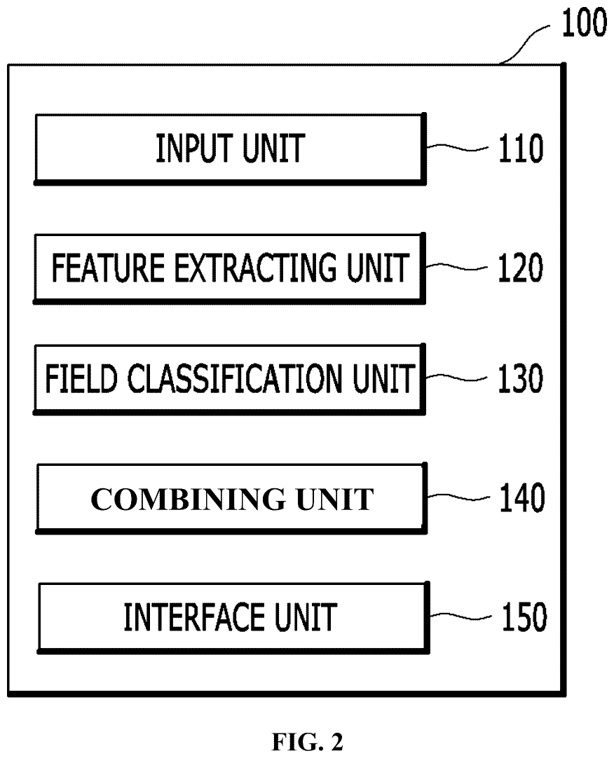

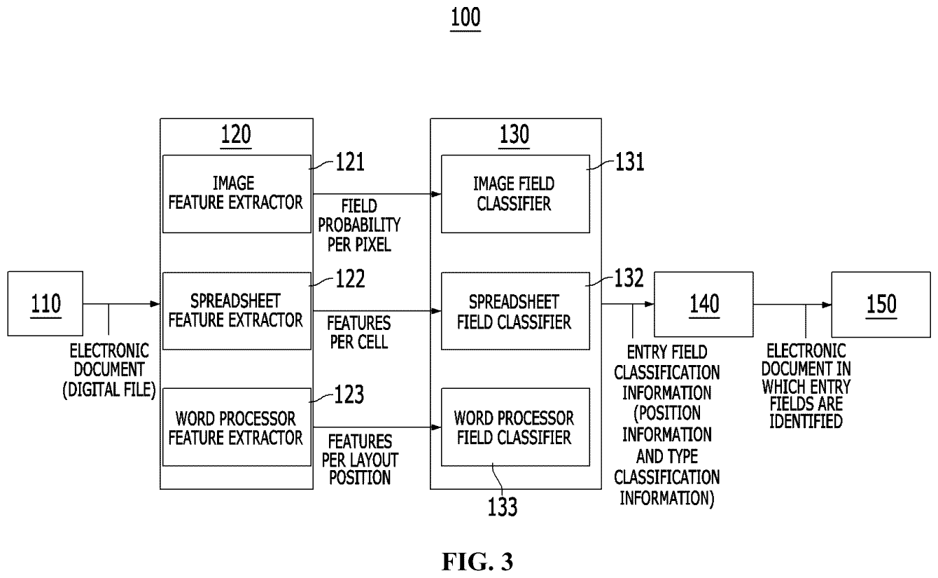

FIG. 2 is a schematic configuration diagram of an apparatus 100 for identifying entry fields in electronic documents according to an exemplary embodiment of the present disclosure, and FIG. 3 is a conceptual diagram schematically illustrating an operation process of the apparatus 100 for identifying entry fields in electronic documents according to an exemplary embodiment of the present disclosure.

Referring to FIGS. 2 and 3, the apparatus 100 for identifying entry fields in electronic documents according to an exemplary embodiment of the present disclosure can include an input unit 110, a feature extraction unit 120, and a field classification unit 130.

The input unit 110 can receive the original electronic document 1 in which entry field information including type information and position information on an entry field is unidentified. The original electronic document 1 can be provided in various data types. For example, the original electronic document 1 can be provided in various types such as a type of an electronic document including image data composed of a plurality of pixels, a type of an electronic document including structured data such as a spreadsheet document including a plurality of cells, and a type of an electronic document including document data such as a word processor document including paragraphs, tables, and/or images.

In this regard, FIG. 3 exemplarily illustrates cases where the structured data and the document data are spreadsheet-based and word-processor-based documents, respectively, but the structured data and the document data are not limited to spreadsheet-based and word-processor-based documents.

For reference, in the description of the exemplary embodiments of the present disclosure, the image data can include, for example, image files having extensions such as png and jpg, the structured data can include, for example, spreadsheet document files having extensions such as xlsx, and the document data can include, for example, word processor document files having extensions such as docx, but are not limited thereto.

In the description of the exemplary embodiments of the present disclosure, the entry field information derived from the original electronic document 1 through an AI-based model can be information on an input field for filling in the electronic document template 2 based on user input to the electronic document template 2, and can include position information and type (kind) information of each input field.

In other words, in the description of the exemplary embodiments of the present disclosure, the electronic document template 2 can refer to the electronic document itself in the form of a format that allows each input field to be filled in (completed) by identifying the input fields based on the entry field information derived (analyzed) through an AI-based model, or can refer to the format of the electronic document.

In the following description, a first feature extraction unit 121, a second feature extraction unit 122, and a third feature extraction unit 123 can be interchangeably referred to as an image feature extractor, a spreadsheet feature extractor, and a word processor feature extractor, respectively. A first field classification unit 131, a second field classification unit 132, and a third field classification unit 133 can be interchangeably referred to as an image field classifier, a spreadsheet field classifier, and a word processor field classifier, respectively.

The feature extraction unit 120 can extract feature information for deriving the entry field information from the original electronic document 1 in consideration of the type of the original electronic document 1.

According to an exemplary embodiment of the present disclosure, the original electronic document 1 can include image data, and the feature extraction unit 120 can include the first feature extraction unit 121 that inputs probability information associated with the type information corresponding to each pixel included in the image data into a pre-trained deep learning model to extract the probability information as the feature information, but is not limited thereto.

When the original electronic document 1 received through the input unit 110 includes image data, feature information can be extracted using the image feature extractor. For example, the image feature extractor can employ a transformer-based deep learning model, and thereby extract a predetermined feature from the entire image data (in other words, all of the plurality of pixels included in the image data, etc.). Specifically, an image can be pre-processed such that the processed image is provided as an input of the deep learning model, and an output matrix having a size of a (height)*b (width)*c (class) can be obtained, where a is the number of height pixels, b is the number of width pixels, and c is the number of types of input components to be classified. By applying a softmax function at every individual pixel location in an image, a probability for a pixel can be obtained, and thereafter, decoding can be performed based thereon. The softmax technique can be related to semantic segmentation, which is a computer vision task that classifies each pixel in an image into a predefined category. The decoding can be performed one of the methods as follows: one method of the decoding is to reduce the image size (using methods, such as, min pooling, and the like) and determine the part where the probability meets a certain criterion (for example, 0.7) as the correct answer, and setting the coordinates (for example, (x, y)) of the applicable part as blanks; alternatively, the decoding can be performed by calculating the probability for each specific aspect ratio, constructing a Gaussian Mixture Model (GMM) based on the calculation, and setting the coordinates of the part meeting the certain criterion as blanks, but not limited thereto.

According to one implementation embodiment of the present disclosure, the probability information can include a plurality of probability values corresponding to probabilities that each pixel corresponds to text, a blank, and each of preset entry field types, but is not limited thereto.

Among the plurality of probability values, the probability value corresponding to the preset entry field type can increase in number as the number of entry field types, such as a signature box and a text box, increases, and accordingly, the number of probabilities corresponding to each pixel can also increase. Specifically, according to the implementation embodiment of the present disclosure, the probabilities corresponding to text and a blank can be calculated as one each, but are not limited thereto, and the number of probabilities corresponding to the preset entry field types can increase as the number of types of entry fields to be reflected in the electronic document template 2 increases.

According to one implementation embodiment of the present disclosure, the original electronic document 1 can include structured data including a plurality of cells, and the feature extraction unit 120 can include the second feature extraction unit 122 configured to extract format information and content information of each of the plurality of cells as the feature information, but is not limited thereto. Specifically, the content information of each of the plurality of cells refers to a text filled in each cell and includes name, data, position of each cell, and the like, and the format information is formatting information for each cell and, along with the content information, serves an important feature that determines the input component type for each cell. The format information includes information of row and column (such as row/column), information showing whether cells are merged (such as rowSpan/colSpan), information showing whether a value exists in the cell (such as value), and border related features (such as borderTop, borderBottom, borderLeft, borderRight and borderTopName, borderBottom Name, borderLeftName, borderRightName), but not limited thereto.

When the original electronic document 1 received through the input unit 110 includes structured data including a plurality of cells such as a spreadsheet document, features can be extracted from the spreadsheet feature extractor. Specifically, the spreadsheet document can include cells representing entry fields to be filled in and cells that have already been filled in, and the spreadsheet feature extractor can extract the format information and the content information of each of the plurality of cells in the spreadsheet document as the feature information.

According to one implementation embodiment of the present disclosure, the original electronic document 1 can include document data, and the feature extraction unit 120 can include the third feature extraction unit 123 configured to extract a plurality of analysis sections constituting the document data through layout analysis of the original electronic document, and to extract the format information and content information of each of the plurality of analysis sections as the feature information, but is not limited thereto. Specifically, the content information of each of the plurality of analysis sections refers to a text filled in each analysis section and includes name, data, position of each analysis section, and the like. The format information refers to formatting information for each analysis section and, along with the content information, serves an important feature that determines the input component type for each analysis section. The format information includes a font size (such as int), whether the text is bold, italic, or underlined, whether the text is a table, row in the table, and column in the table, and the like, but is not limited thereto.

When the original electronic document 1 received through the input unit 110 includes document data such as a word processor document including paragraphs, tables, and/or images, features can be extracted from the word processor feature extractor.

The word processor document is generally configured in a linear flow of text constituting paragraphs and can include tables and/or images in the document, and the positions and sizes of the paragraphs, tables, and images are not fixed. The word processor feature extractor can extract a plurality of analysis sections including the data regarding paragraphs, tables, and/or images constituting the word processor document, and extract the format information and content information of each of the extracted plurality of analysis sections as the feature information. The feature information can be extracted through XML format (for example, docx OOXML) of the word document. However, this method can be difficult to determine the exact location of components. Thus, converting the word document to another format, such as PDF or Excel, and then extracting the information can be also used. Alternatively, a language model specialized in layout analysis, such as MarkUpLM, to extract the feature information can be implemented.

Specifically, content information can be extracted from the paragraphs or text in the tables among the analysis sections through methods such as word embedding, and when the analysis section has a format applied thereto, the format information can also be extracted together as the feature information. In addition, the tables and images among the analysis sections can each extract the feature information through their respective separate formats and contents.

Meanwhile, the field classification unit 130 can identify the entry field information from the feature information extracted by the feature extraction unit 120.

As described above, the feature extraction unit 120 can extract the feature information for deriving the entry field information from the original electronic document 1 through different feature extractors depending on the type of the original electronic document 1.

Similarly, in the field classification unit 130, each of the feature information extracted through different feature extractors depending on the type of the original electronic document 1 can derive the entry field information from the feature information by a different field classifier.

According to one implementation embodiment of the present disclosure, the field classification unit 130 can include a first field classification unit 131 configured to identify the type information based on the probability information, and recognize the position information and the size information of the entry field based on a pixel having the highest probability value, but is not limited thereto. Specifically, for example, in a case where the classification unit identifies a particular pixel with three types of type information (a blank, a text, and a preset entry field), and if a probability that the particular pixel is a text is 0.1, a probability that the pixel is a blank is 0.2, and a probability that the pixel is a preset entry field type is 0.7, the pixel is determined as the preset entry field because 0.7 is the largest probability among the probabilities. The position information and the size information respectively indicate the position and the size of a particular entry field.

The feature information extracted through the image feature extractor can include a plurality of probability values corresponding to probabilities that each pixel corresponds to text, a blank, and a preset entry field, and the image field classifier can perform a task of identifying the position, shape, and type of the entry field by using the feature information.

Specifically, the position information of the portion corresponding to the entry field can be specified based on the pixel having the highest probability value in consideration of the probability values of each pixel included in the entry field, and the type information of the entry field can be identified by determining which type, such as a box type, an underline type, or a colon type, is appropriate for the entry field.

According to one implementation embodiment of the present disclosure, the field classification unit 130 can include a second field classification unit 132 that inputs the feature information to a pre-built AI model to derive whether each of the plurality of cells corresponds to an entry field and a probability associated with the type information, and recognizes the type information and the position information of each of the plurality of cells based on the derived probability, but is not limited thereto. Specifically, the pre-built AI can extract the features of each of the plurality of cells by opening a document (such as, office open XML (OOXML) format documents) in order to determine whether each of the plurality of cells corresponds to an entry field and a probability associated with the type information and the position, but not limited thereto.

The AI model can employ a pre-trained decision tree-based machine learning model, a deep learning model, or a hybrid model. The spreadsheet feature extractor can input the extracted feature information to the AI model to derive whether each of the plurality of cells corresponds to an entry field and a probability associated with the type information, and identify the type information and the position information of each of the plurality of cells based on the derived probability. The type information of each of the plurality of cells can include text box, a number/date box, a signature box, and the position information of each of the plurality cells can indicate a position of each of the plurality cells, but not limited thereto.

According to one implementation embodiment of the present disclosure, the field classification unit 130 can include a third field classification unit 133 configured to utilize the feature information as input to an ensemble model to derive a probability that each of the plurality of analysis sections corresponds to an entry field, and determine the position information so that there is no interference between an analysis section identified as corresponding to an entry field and an analysis section identified as not corresponding to an entry field, but is not limited thereto.

The word processor field classifier can utilize the feature information, including the format information and the content information of each of the plurality of analysis sections (paragraph, table, or image) extracted from the word processor feature extractor, as input to the ensemble model to derive a probability that each of the plurality of analysis sections corresponds to an entry field, and identify the type information and the position information of the entry field by accurately specifying the position information so that there is no interference between an analysis section identified as corresponding to an entry field and an analysis section identified as not corresponding to an entry field.

Meanwhile, referring to FIGS. 2 and 3, the apparatus 100 for identifying entry fields in electronic documents according to an exemplary embodiment of the present disclosure can include a combining unit 140 and an interface unit 150.

According to one implementation embodiment of the present disclosure, the combining unit 140 can combine the original electronic document 1 and the entry field information to generate the electronic document template 2 in which the entry fields are identified.

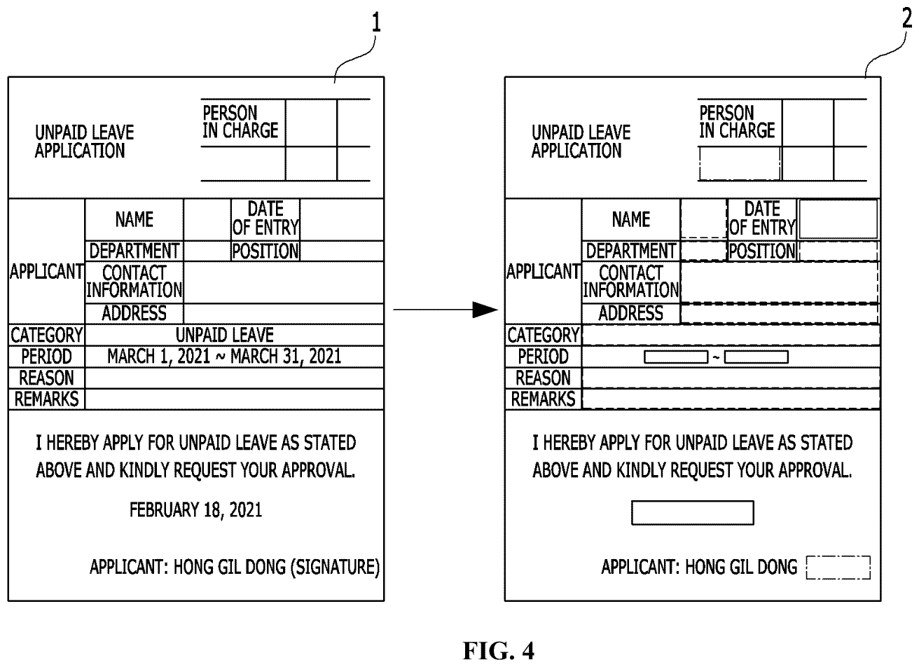

FIG. 4 is a diagram illustrating generation of an electronic document template 2 from an original electronic document 1 by the apparatus 100 for identifying entry fields in electronic documents according to an exemplary embodiment of the present disclosure. Specifically, FIG. 4 is a diagram illustrating an example of a case where an original electronic document 1 is an unpaid leave application written using a word processor.

Referring to FIG. 4, the apparatus 100 for identifying entry fields in electronic documents according to the present disclosure can classify each entry field from the unpaid leave application, which is the original electronic document 1 in which entry field information including type information and position information on the entry field is unidentified, into type information (which specifies the type of the entry field information), such as, a text box (dashed line), a number/date box (solid line), and a signature box (dot-dashed line) displayed in the electronic document template 2, specify the position information of each entry field, identify the entry field information including the type information and the position information, and combine the original electronic document 1 and the entry field information to provide the user with the electronic document template 2 in which the entry fields are identified. The position information can be, for example, the position of the text box, the number/date box, and the signature box, but not limited thereto.

In this regard, according to one implementation embodiment of the present disclosure, the interface unit 150 can output an interface for receiving user input according to the entry field information by using the electronic document template 2.

The interface unit 150 can output an interface for receiving user input by using the electronic document template 2 generated by the combining unit 140, and through this, the user can check the entry fields to be filled in within the electronic document, input content data to be entered into each entry field, and finally complete writing the electronic document.

One of ordinary skill in the art would understand in light of the disclosure that the term “unit” can be software, hardware or combination thereof. As hardware, it can refer to a computing component including a computer processor and a memory for storing computer software codes (instructions) executable by the computer processor. Accordingly, the input unit 110, the feature extraction unit 120, the first feature extraction unit 121, the second feature extraction unit 122, the third feature extraction unit 123, the field classification unit 130, the first field classification unit 131, the second field classification unit 132, the third field classification unit 133, the combining unit 140, and the interface unit 150 can be implemented by a processor and a memory for storing a computer program code, and more specifically, the computer program code, when executed by the processor, can cause the apparatus 100 to perform the functioning of the input unit 110, the feature extraction unit 120, the first feature extraction unit 121, the second feature extraction unit 122, the third feature extraction unit 123, the field classification unit 130, the first field classification unit 131, the second field classification unit 132, the third field classification unit 133, the combining unit 140, and the interface unit 150, but not limited thereto.

In addition, a second aspect of the present disclosure can provide a method for identifying entry fields in electronic documents using the apparatus 100 for identifying entry fields in electronic documents based on AI according to the first aspect of the present disclosure.

For the method for identifying entry fields in electronic documents according to the second aspect of the present disclosure, detailed descriptions of parts overlapping with the first aspect of the present disclosure are omitted, but even if the description is omitted, the contents described in the first aspect of the present disclosure can be equally applied to the second aspect of the present disclosure.

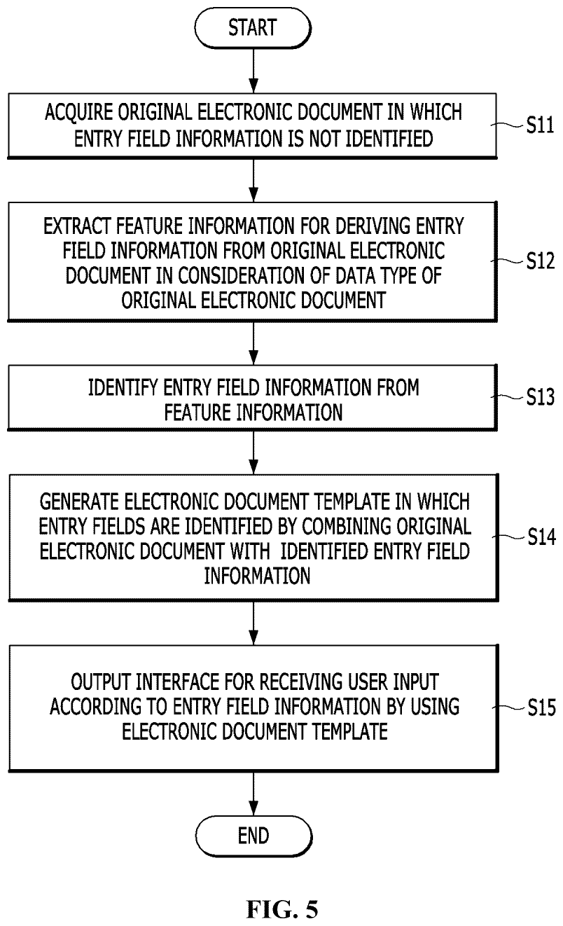

FIG. 5 is a flowchart illustrating a method for identifying entry fields in electronic documents according to an exemplary embodiment of the present disclosure.

Referring to FIG. 5, in step S11, the input unit 110 can acquire the original electronic document 1 in which entry field information is unidentified.

Next, in step S12, the feature extraction unit 120 can extract feature information for deriving the entry field information from the original electronic document 1 in consideration of the type of the original electronic document 1.

Next, in step S13, the field classification unit 130 can identify the entry field information from the feature information.

Next, in step S14, the combining unit 140 can combine the original electronic document 1 and the entry field information to generate the electronic document template 2 in which the entry fields are identified.

Next, in step S15, the interface unit 150 can output an interface for receiving user input according to the entry field information by using the electronic document template 2 generated in step S14.

In the above description, steps S11 to S15 can be further divided into additional steps, or combined into fewer steps according to the implementation embodiment of the present disclosure. In addition, some steps can be omitted if necessary, and the order between the steps can be changed.

The method for identifying entry fields in electronic documents according to an exemplary embodiment of the present disclosure can be implemented in the form of program instructions that can be executed through various computer means, and recorded in a computer-readable medium. The computer-readable medium can include program instructions, data files, and data structures alone or in combination. The program instructions recorded on the medium can be those specially designed and configured for the present disclosure, or can be ones known and available to those skilled in the art of computer software. Examples of the computer-readable recording medium include magnetic media such as hard disks, floppy disks, and magnetic tapes, optical media such as CD-ROMs and DVDs, magneto-optical media such as floptical disks, and hardware devices such as ROM, RAM, and flash memory that are specially configured to store and execute program instructions. Examples of the program instructions include machine code such as that produced by a compiler, as well as high-level language code that can be executed by a computer using an interpreter, etc. The above-described hardware devices can be configured to operate as one or more software modules for performing the operations of the present disclosure, and vice versa.

In addition, the aforementioned method for identifying entry fields in electronic documents can be implemented in the form of a computer program or application executed by a computer and stored in a recording medium.

The foregoing description of the present disclosure is intended for illustrative purposes, and those skilled in the art to which the present disclosure pertains will understand that various modifications can be made without changing the technical spirit or essential features of the present disclosure. Therefore, the exemplary embodiments described above are to be understood as illustrative and not restrictive in every respect. For example, each component described as being of a single type can be implemented in a distributed manner, and likewise, components described as being distributed can be implemented in a combined form.

The scope of the present disclosure is indicated by the claims described below, rather than the foregoing detailed description, and it should be construed that all changes or modifications derived from the meaning and scope of the claims and the equivalent concepts are included within the scope of the present disclosure.

1. An apparatus for identifying entry fields in electronic documents based on artificial intelligence, comprising:
at least one processor; and
at least one memory for storing a computer code,
wherein the computer code, when executed by the at least one processor, is configured, with the at least one processor, to cause the apparatus to:
acquire an original electronic document in which entry field information including type information and position information of the entry fields is not identified;
extract feature information for deriving the entry field information from the original electronic document; and
identify the entry field information from the feature information.

2. The apparatus according to claim 1,
wherein the computer program code is further configured to: generate an electronic document template in which the entry fields are identified by combining the original electronic document and the entry field information.

3. The apparatus according to claim 2,
wherein the computer program code is further configured to: output an interface for receiving user input corresponding to the entry field information using the electronic document template.

4. The apparatus according to claim 1, wherein the original electronic document includes image data, and
a pre-trained deep learning model is configured to input probability information associated with the type information for pixels included in the image data so as to extract the feature information.

5. The apparatus according to claim 4, wherein the probability information includes a plurality of probability values for each pixel, and
wherein the plurality of probability values include a probability value whether each pixel is a text, a blank, or a preset entry field.

6. The apparatus according to claim 1, wherein the original electronic document includes structured data having a plurality of cells, and
the feature information includes format information and content information of each of the plurality of cells.

7. The apparatus according to claim 1, wherein the original electronic document includes a plurality of analysis sections, and
the computer program code is configured to extract the plurality of analysis sections through layout analysis of the original electronic document, and the feature information includes format information and content information of each of the plurality of analysis sections.

8. The apparatus according to claim 5, wherein the computer program code is configured to identify the type information based on the probability information, and recognize the position information and size information of each entry field based on a largest probability value of each pixel among the plurality of probability values.

9. The apparatus according to claim 6, wherein the computer program code is configured to input the feature information into a pre-built artificial intelligence model to determine whether each of the plurality of cells matches with one of the entry fields and derive probabilities associated with the type information, and configured to recognize the type information and the position information in connection with each of the plurality of cells based on the derived probabilities.

10. The apparatus according to claim 7, wherein the computer program code is configured to input the feature information to an ensemble model to derive probabilities regarding whether each of the plurality of analysis sections matches with one of the entry fields, and determine the position information such that no interference exists between one or more of the plurality of analysis sections identified as one or more of the entry fields and the remainder of the plurality of analysis sections identified as not any one of the entry fields.

11. A method for identifying entry fields in electronic documents based on artificial intelligence, comprising:
acquiring an original electronic document in which entry field information including type information and position information of the entry fields is not identified;
extracting feature information for deriving the entry field information from the original electronic document; and
identifying the entry field information from the feature information.

12. The method according to claim 11, further comprising:
generating an electronic document template in which the entry fields are identified by combining the original electronic document and the entry field information.

13. The method according to claim 12, further comprising:
outputting an interface for receiving user input corresponding to the entry field information using the electronic document template.

14. The method according to claim 11, wherein the original electronic document includes image data, and
the extracting of the feature information includes extracting probability information associated with the type information for pixels included in the image data by inputting the probability information into a pre-trained deep learning model.

15. The method according to claim 14, wherein the probability information includes a plurality of probability values for each pixel, and
wherein the plurality of probability values include a probability value whether each pixel is a text, a blank, or a preset entry field.

16. The method according to claim 11, wherein the original electronic document includes structured data having a plurality of cells, and
the extracting of the feature information includes extracting format information and content information of each of the plurality of cells.

17. The method according to claim 11, wherein the original electronic document includes a plurality of analysis sections, and
the extracting of the feature information includes extracting the plurality of analysis sections through layout analysis of the original electronic document, and extracting format information and content information of each of the plurality of analysis sections.

18. The method according to claim 15, wherein the identifying of the entry field information includes identifying the type information based on the probability information, and recognizing the position information and size information of each entry field based on a largest probability value of each pixel among the plurality of probability values.

19. The method according to claim 16, wherein the identifying of the entry field information includes inputting the feature information into a pre-built artificial intelligence model to determine whether each of the plurality of cells matches with one of the entry fields and derive probabilities associated with the type information, and recognizing the type information and the position information in connection with each of the plurality of cells based on the derived probabilities.

20. The method according to claim 17, wherein the identifying of the entry field information includes inputting the feature information to an ensemble model to derive probabilities regarding whether each of the plurality of analysis sections matches with one of the entry fields, and determining the position information so that interference does not occur between one or more of the plurality of analysis sections identified as one or more of the entry fields and the remainder of the plurality of analysis sections identified as not any one of the entry fields.
